(19) United States
(12) Patent Application Publication
(10) Pub. No.: US 2007/0247371 A1
(43) Pub. Date: Oct. 25, 2007

(54) DUAL SPHERE UWB ANTENNA

(76) Inventor: Waldemar Kunysz, Calgary (CA)

Correspondence Address: CESARI AND MCKENNA, LLP, 88 BLACK FALCON AVENUE, BOSTON, MA, 02210, US

(21) Appl. No.: 11/693,880

(22) Filed: Mar. 30, 2007

Related U.S. Application Data
(60) Provisional application No. 60/794,706, filed on Apr. 25, 2006.

(51) Int. Cl. H01Q 1/38

(52) U.S. Cl. 343/700 MS

(57) ABSTRACT

An antenna that is suitable for transmission and reception of UWB signals is provided. The antenna includes a pair of conducting spheres separated by an air gap. A first conducting sphere is connected to a first conductor of a transmission line and a second conducting sphere is connected to a second conductor of the transmission line. The dual sphere antenna provides consistent performance in the azimuth plane and across the frequency band for UWB applications.

### CROSS-REFERENCE TO RELATED APPLICATIONS

The present application claims the benefit of U.S. Provisional Patent Application Ser. No. 60/794,706, which was filed on Apr. 25, 2006, by Waldemar Kunysz for a DUAL SPEHERE UWB MONOPOLE ANTENNA and is hereby incorporated by reference.

### BACKGROUND OF THE INVENTION

1. Field of the Invention

The present invention is related to ultra wide band (UWB) antennas and, more particularly, to UWB antennas having uniform radiation patterns.

2. Background Information

A portion of the electromagnetic spectrum has been allocated by the U.S. government for transmission of UWB signals. The U.S. Federal Communication Commission has defined UWB signals as any signal that occupies a bandwidth of at least 500 MHz within the spectrum between 3.1 GHz and 10.6 GHz. Comparatively, traditional wireless radio frequency signals are transmitted within a narrow band around a particular center frequency.

A wide range of UWB applications has been recently developed. Such applications include ground penetrating radars, high data rate short range wireless local area networks, military communications systems and short pulse radars for automotive and robotics applications. Such systems require antennas that are able to operate across a wide bandwidth while maintaining a consistent polarization and consistent radiation pattern parameters over the entire band. Traditional antenna designs that were suitable for transmission and reception of narrow band electromagnetic signals are unsuitable for UWB signals because their performance is strongly related to the frequencies of the transmitted and received signals.

One important antenna characteristic is its impedance bandwidth. The impedance bandwidth indicates the bandwidth for which an antenna is sufficiently matched to its input transmission line such that 10% or less of an incident signal is lost by being reflected by the antenna back into the transmission line. A reflection coefficient Γ can be determined to characterize the impedance matching of a particular antenna to its transmission line. The reflection coefficient Γ is defined as the ratio of a reflected wave Vo⁻ to the incident wave Vo⁺ at the antenna terminals.

Return loss is another parameter that is commonly used to characterize impedance matching of an antenna to its transmission line. Return loss is defined as −20log (|Γ|). A return loss greater than 10 dB, which corresponds to a reflection coefficient F of less than 0.3162, is indicative of a good impedance match. A UWB antenna should have good impedance matching across the full UWB signal spectrum from 3.1 GHz to 10.6 GHz.

Group delay is an antenna characteristic that is particularly important for antennas that are used to communicate UWB signals. Group delay is defined as the derivative of a signal's phase as a function of frequency over a range of frequencies and is constant if the phase is linear over the range of frequencies. UWB applications require an antenna that performs throughout the entire UWB frequency band without suffering excessive pulse distortion or dispersion. To minimize distortion, it is desirable to achieve a linear phase-frequency relationship as indicated by a constant group delay across the UWB band.

An antenna's radiation pattern and radiation efficiency must also be considered in UWB antenna design. As is the case in most general antenna applications, it is desirable for UWB antennas to achieve a nearly uniform, omni-directional radiation pattern. In UWB applications, it is particularly important to achieve a uniform radiation pattern and to thereby maximize radiation efficiency because the power spectral density of transmitted UWB signals is extremely low.

Inexpensive antennas such as printed monopole antennas, micro-strip patch antennas and thin dipole antennas exhibit omni-directional characteristics and have therefore been widely used in mobile communication systems but are unsuitable for communication of UWB signals.

Several known antenna topologies such as the horn antenna, bicone antenna and helix antenna have excellent broadband characteristics but are physically large and too cumbersome for typical applications. Other known UWB antennas such as log-periodic antennas and spiral antennas radiate different frequency components from different portions of their structure resulting in undesirable signal dispersion across the UWB band.

Recently, several broadband monopole antenna geometries have been proposed for UWB applications. These monopole geometries generally exhibit a wide bandwidth but they do not exhibit sufficiently omni-directional radiation patterns. For example, a circular disk monopole UWB antenna includes a ground plane which serves as an impedance matching circuit. Electric currents on the ground plane are mainly distributed on the upper edge along its circumference. The portion of the ground plane close to the monopole disk acts as a part of the radiating structure. Consequently, the performance of the circular disk monopole UWB antenna is dependent on the width of the ground plane.

Currently known UWB antennas thus suffer from inconsistent performance across a wide frequency range and/or significant alteration to a transmitted or received UWB pulse shape due to large variations in group delay with changes in frequency, azimuth and elevation angle. Certain known UWB antennas are also impractical for use in mass produced applications because they are too large, unwieldy and/or difficult to manufacture. Accordingly, what is needed is a compact efficiently manufacturable UWB antenna that can provide wide bandwidth, omni-directionality, consistent polarization and consistent group delay over the broad frequency range to which the antenna is used.

### SUMMARY OF THE INVENTION

The antenna embodying the invention includes a pair of identical conducting spheres separated by an air gap. One of the spheres is electrically connected to a first conductor of a transmission line and the other of the spheres is electrically connected to a second conductor of the transmission line. The transmission line carries a signal to the antenna from a balanced feed generator. A similarly configured antenna can be used for receiving the UWB signals. The dual sphere antenna provides constant group delay, and uniform radiation patterns across the UWB frequency band.

### BRIEF DESCRIPTION OF THE DRAWINGS

The invention description below refers to the accompanying drawings, of which:

FIG. 1 is a cross-sectional view of a dual sphere antenna;

FIG. 2 is a graph of the measured return loss in dB of a dual sphere antenna across a frequency range of 4 GHz to 8.5 GHz;

FIG. 3 is a graph of the measured group delay in nanoseconds of a dual sphere antenna across a frequency range of 4 GHz to 8.5 GHz;

FIG. 4 is a schematic diagram of a UWB transmitter including a UWB antenna; and

FIG. 5 is a graph of UWB signal amplitude versus time for UWB signals transmitted and received using a UWB.

### DETAILED DESCRIPTION

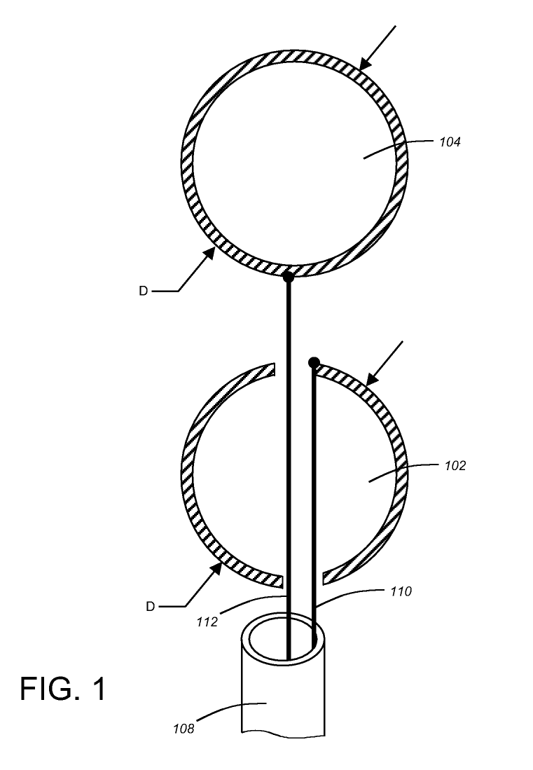

Referring to FIG. 1, an antenna 100 has a first conducting sphere 102 and a second conducting sphere 104. The spheres 102, 104 have the same diameter D and are separated by a non-conducting gap such as an air gap 106. A transmission line 108 is connected to the antenna 100 such that a first conductor 110 of the transmission line 108 is electrically connected to the first sphere 102 and a second conductor 112 of the transmission line 108 is electrically connected to the second sphere 104. The second conductor 112 passes through but is electrically isolated from the first sphere 102.

The diameters D of the spheres 102, 104 are between about 6.0 mm and about 6.35 mm. The surface to surface gap 106 is about 1.5 mm to about 2.0 mm. The spheres 102, 104 may be constructed from hollow conductors, conductive shells surrounding nonconductive materials, or solid conductor materials, for example. The transmission line 108 is preferably a coaxial cable wherein the conductor 110 is the outer conductor and the conductor 112 is the inner conductor.

The antenna 100 is referred to hereinafter as a “dual sphere” antenna. The antenna 100 provides consistant performance in the azimuth plane and across the UWB frequency range. A dual sphere antenna that is oriented along a vertical axis exhibits a nearly uniform spherical radiation pattern with only a small null aligned with the vertical axis.

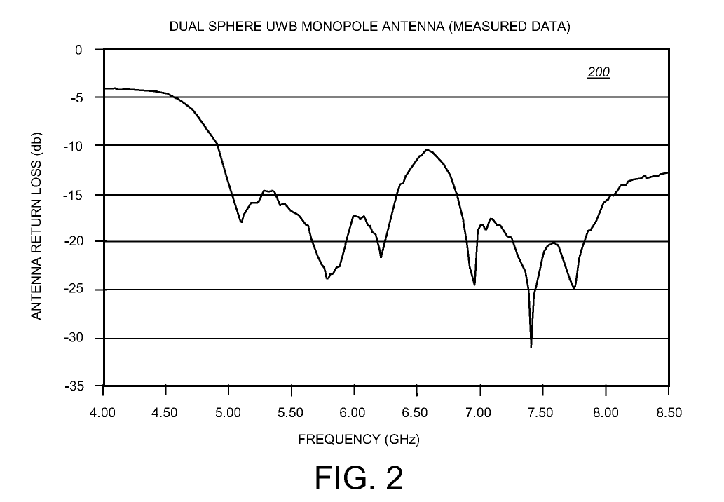

FIG. 2 is a graph of measured return loss 200 for a dual sphere antenna in the frequency band between 4 GHz and 8.5 GHz. The measured return loss 200 of between about −4 dB and −31 dB is indicative of good performance across this frequency band. The dual sphere antenna also exhibits an acceptable return loss across the 3 GHz to 4 GHz frequency band.

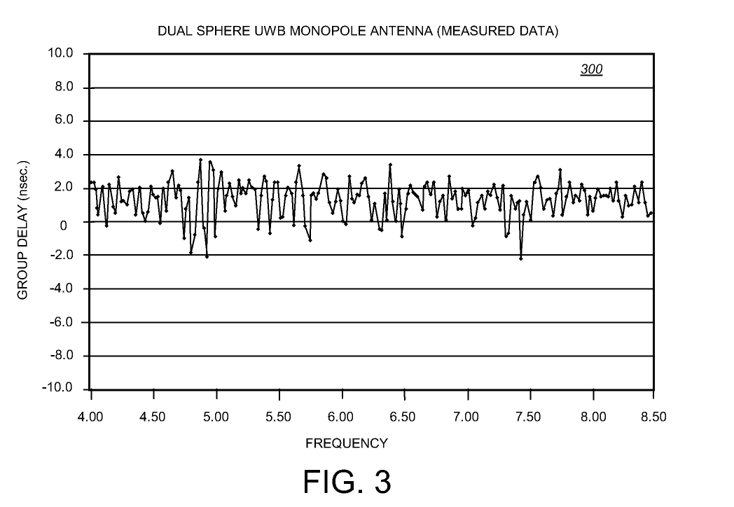

FIG. 3 illustrates the measured antenna group delay 300 in nanoseconds of a dual sphere antenna in the frequency band between 4 GHz to 8.5 GHz. The dual sphere antenna exhibits essentially constant group delay 300 within about two nanoseconds across the UWB frequency band.

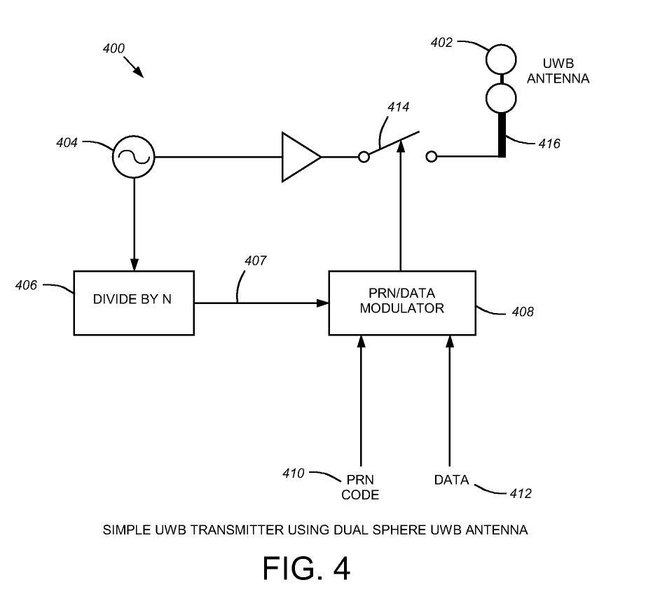

FIG. 4 is a schematic diagram of a UWB transmitter 400 driving a dual sphere UWB antenna 402. A continuous wave (CW) input signal 404 is modulated by a pseudo-random noise (PRN)/Data Modulator 408. The input signal 404 is fed through a divide by N module 406 to reduce its frequency and provide a modulation signal 407 having a frequency suitable for input to the PRN/Data Modulator 408. A PRN code 410 and a data signal 412 are also input to the PRN/Data Modulator 408. In response to the modulation signal 404, the PRN code 410 and the data 412, the PRN/Data Modulator controls switching circuitry 414 to produce pulses which are communicated to the antenna 402 via a transmission line 416.

A UWB transmitter 400 that includes a PRN/Data Modulator 408 which uses SRD diodes is capable of modulating the CW input signals 404 up to about 1.6 GHz to produce a modulated pulse train transmission. At frequencies greater than about 1.6 GHz, parasitic capacitance associated with the SRD diode circuitry limits operation of the PRN/Data Modulator 408 such that the CW input signal 404 passes directly to the transmission line 416 and UWB antenna. Accordingly, at frequencies above 1.6 GHz, the data signal becomes difficult to detect in the CW signal 404. However, at these higher frequencies, the dual sphere antenna begins to differentiate the data signal from the CW signal and effectively transmits pulses representing the modulated data signal. A dual sphere receiving antenna coupled to demodulation circuitry can retrieve the data using the PRN code in a known manner.

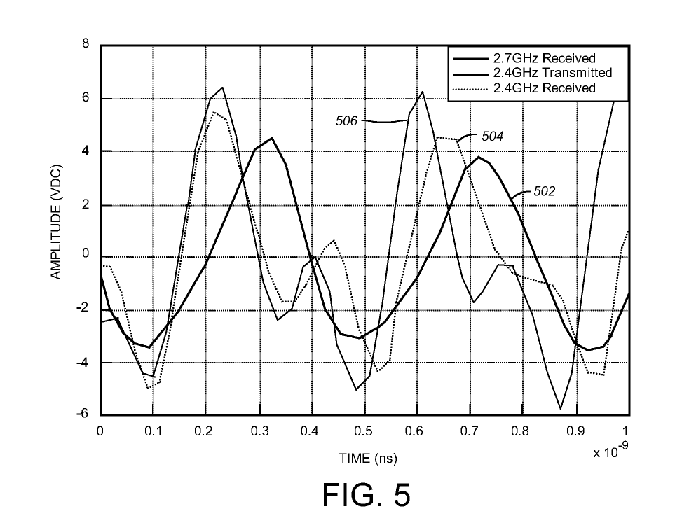

A UWB transmitter driving a dual sphere antenna can operate at higher frequencies without requiring a more complex modulator or more complex UWB pulse shaper circuitry than is required in conventional UWB transmitters because the dual sphere antenna can differentiate a data signal in the higher frequency carrier signal. The ability of a dual sphere antenna to differentiate a data signal from a carrier signal of greater than about 1.6 GHz can be seen more clearly with reference to FIG. 5. FIG. 5 is a graph of signal amplitude versus time in nanoseconds for a transmitted UWB signal 502 at 2.4 GHz, a received UWB signal 504 at 2.4 GHz and a received UWB signal 506 at 2.7 GHz.

While the invention has been described with reference to various illustrative embodiments, it should be understood by those skilled in the art that various changes may be made and equivalents may be substituted for elements thereof without departing from the scope of the invention. In addition, many modifications may be made to adapt a particular situation or material to the teachings of the invention without departing from the scope thereof. Therefore, it is intended that the invention not be limited to the particular embodiment disclosed as the best mode contemplated for carrying out this invention, but that the invention will include all embodiments falling within the scope of the appended claims.

Although embodiments of the invention are described herein as including a first and second conducting sphere, it should be understood that various alternative embodiments of the present invention comprise a pair of conducting elements which are not necessarily spherical. For example, the first and second conducting “spheres” may include dimples or other irregularities without departing from the scope of the present disclosure. Furthermore, non-spherical conducting elements such as tetrahedral, octahedral or teardrop shaped elements may be used. The size of the conducting elements and gap therebetween may also be varied within the scope of the present disclosure, as long as the conducting elements are substantially identical.

What is claimed is:

1. An ultra-wideband (UWB) antenna, comprising:
a first conducting sphere of diameter D having a conductive surface;
a second conducting sphere of diameter D having a conductive surface; and
a non-conducting gap between the first sphere and second sphere.

2. The antenna of claim 1, further comprising:
a transmission line having a first conductor and a second conductor, the first conductor being electrically connected to the conductive surface of the first sphere and the second conductor being electrically connected to the conducting surface of the second sphere.

3. The antenna of claim 1, further comprising:
a non-conducting channel through the first conducting sphere, wherein the second conductor extends through the non-conducting channel.

4. The antenna of claim 1, wherein the first conductor is the outer conductor of a coaxial cable and the second conductor is the inner conductor of a coaxial cable.

5. The antenna of claim 1 wherein the diameter D is between about 6.0 mm and about 6.35 mm.

6. The antenna of claim 5 wherein the surface to surface distance between the first sphere and the second sphere is between about 1.5 mm and about 2.0 mm.

7. The antenna of claim 5 wherein the center to center distance between the first sphere and the second sphere is between about 13.5 mm and about 14.0 mm.

8. The antenna of claim 1 wherein the first sphere and the second sphere are made from a metal coated insulator.

9. The antenna of claim 1 wherein the first sphere and second sphere are solid metal spheres.

10. The antenna of claim 1 wherein the first sphere and second sphere are hollow metal spheres.

11. An ultra-wideband (UWB) transmitter, comprising:
a continuous wave signal generator;
a pseudo-random noise/data modulator in communication with the continuous wave signal generator receiving a UWB continuous wave signal therefrom, the pseudo-random noise/data modulator also receiving a pseudo-random noise code and data;
switching circuitry in communication with the continuous wave signal generator and in communication with the pseudo-random noise/data modulator, the switching circuitry effecting modulation of the continuous wave signal in response to control of the switching circuitry by the PRN/Data Modulator to produce a modulated UWB signal;
a transmission line in communication with the switching circuitry and receiving a modulated UWB signal therefrom;
a dual sphere UWB antenna in communication with the transmission line and receiving the modulated UWB signal therefrom.

12. The UWB transmitter of claim 11 wherein the dual sphere antenna further comprises:
a first sphere of diameter D having a conductive surface;
a second sphere of diameter D having a conductive surface; and
a non-conducting gap between the first sphere and second sphere.

13. The UWB transmitter of claim 11, wherein the transmission line includes a first conductor connected to the first sphere and a second conductor connected to the second sphere.

14. The UWB transmitter of claim 11, wherein the switching circuitry comprises an SRD diode, and wherein the continuous wave signal has a frequency greater than about 1.6 GHz.

15. The UWB transmitter of claim 14 wherein the continuous wave signal has a frequency between about 2.4 GHz and 2.7 GHz.

16. A method of transmitting data comprising:
modulating a continuous wave signal with the data; and
providing the modulated continuous wave signal to a dual sphere UWB antenna.

17. The method of claim 16 wherein the dual sphere UWB antenna comprises:
a first sphere of diameter D of between about 6.0 mm and about 6.35 mm;
a second sphere of diameter D disposed at a surface to surface distance of between about 1.5 mm and 2.0 mm from the first sphere; and
a non-conducting gap between the first sphere and second sphere.

18. The method of claim 16 wherein the modulating is performed using SRD switching circuitry.

19. The method of claim 18 wherein the continuous wave signal has a frequency greater than about 1.6 GHz.

20. The method of claim 18 wherein the continuous wave signal has a frequency between about 2.4 GHz and about 2.7 GHz.
